(19) United States
(12) Patent Application Publication
(10) Pub. No.: US 2011/0227964 A1
(43) Pub. Date: Sep. 22, 2011

(54) LIFETIME UNIFORMITY PARAMETER EXTRACTION METHODS

(75) Inventors: GHOLAMREZA CHAJI, Waterloo (CA); Javid Jaffari, Kitchener (CA); Arokia Nathan, Cambridge (GB)

(73) Assignee: Ignis Innovation Inc., Kitchener (CA)

(21) Appl. No.: 13/050,006

(22) Filed: Mar. 17, 2011

(30) Foreign Application Priority Data
Mar. 17, 2010 (CA) 2696778

(51) Int. Cl. G09G 5/10

(52) U.S. Cl. 345/690; 345/82

(57) ABSTRACT

A system and method for deriving a sequence of OLED non-uniformity test patterns. A pattern generator generates a full sequence of display patterns according to a transform function, such as a discrete cosine transformation or wavelet transformation. A driver drives a display with each of the sequence of patterns. A sensor senses a property of the display, such as a total current for the display, for each of the sequence of patterns. An extraction unit derives a pixel non-uniformity model using the sensed properties and an inverse of the transform function. Patterns that contribute less than a threshold amount to the non-uniformity model can be identified and deleted to derive a sparse sequence of patterns, which can be stored in a memory. The sparse sequence of patterns can be used to test the display and extract a set of pixel non-uniformity values. The pixel non-uniformity values can be used to generate a correction signal for the display.

### CROSS-REFERENCE TO RELATED APPLICATIONS

This application claims priority to Canadian Application No. 2,696,778, which was filed Mar. 17, 2010.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE PRESENT DISCLOSURE

The present invention generally relates to active matrix organic light emitting device (AMOLED) displays, and particularly to improving the spatial and/or temporal uniformity of a display.

### BACKGROUND

Organic light emitting diode (OLED) displays have gained significant interest recently in display applications in view of their faster response times, larger viewing angles, higher contrast, lighter weight, lower power, amenability to flexible substrates, as compared to liquid crystal displays (LCDs).

Currently, active matrix organic light emitting device (“AMOLED”) displays are being introduced. The advantages of such displays include lower power consumption, manufacturing flexibility and faster refresh rate over conventional liquid crystal displays. In contrast to conventional liquid crystal displays, there is no backlighting in an AMOLED display as each pixel consists of different colored OLEDs emitting light independently. The OLEDs emit light based on current supplied through a drive transistor.

An AMOLED display includes an array of rows and columns of pixels, each having an organic light-emitting diode (OLED) and backplane electronics arranged in the array of rows and columns. Since the OLED is a current driven device, the pixel circuit of the AMOLED should be capable of providing an accurate and constant drive current. Active matrix addressing involves a layer of backplane electronics, based on thin film transistors (TFTs) fabricated using amorphous silicon (a-Si:H), polycrystalline silicon (poly-Si), or polymer technologies, to provide the bias voltage and drive current needed in each OLED based pixel.

AMOLED displays can experience non-uniformity, for example due to manufacturing processes and differential ageing. Individual pixels of an AMOLED display may age differently from other pixels due to the images displayed on the display over time. Ageing of both the TFT backplane and the OLEDs for a particular pixel can separately contribute to the ageing of that pixel. Additionally, different color OLEDs are made from different organic materials, which age differently. Thus, the separate OLEDs for a pixel may age differently from one another. As a result, the same drive current may produce a different brightness for a particular pixel over time, or a pixel's color may shift over time. Measuring the status (e.g., ageing, non-uniformity, etc.) of an AMOLED display can require that each individual pixel be measured. This requires a great many measurements, and a number of measurements that increases as the number of pixels increases.

### SUMMARY

Aspects of the present disclosure include a method of evaluating OLED display pixel status (e.g., pixel ageing and/or pixel non-uniformity). The method includes generating a sequence of patterns representing pixel values for a display panel, wherein the sequence of patterns is a subset of a full sequence of patterns and driving the OLED panel with the sequence of patterns. A sequence of values representing the responses of the panel to the respective ones of the sequence of patterns is sensed and a matrix of status values representing pixel status of the panel is derived from the sensed sequence of values. The matrix of status values is stored in a memory, and can be used in applying a correction signal to the display. The patterns can be generating using, for example, discrete cosine transformations, wavelet transformations, or principal component analysis. Measurements can be taken while operating the display at multiple operating points (e.g., driving transistors in a saturation region and a linear region), allowing status values to be extracted for multiple discrete display characteristics (e.g., driving transistor TFT ageing and OLED pixel ageing).

According to another aspect of the disclosure, an apparatus for evaluating OLED display status (e.g., ageing and/or non-uniformity) includes a pattern generator configured to generate a sequence of pixel patterns, wherein the sequence of patterns is a subset of a full sequence of patterns. A pixel driver coupled to the pattern generator is configured to drive a display panel with the sequence of pixel patterns. A sensor is configured to sense a panel response value corresponding to a pattern generated by the pattern generator and an extraction module coupled to the sensor is configured to extract a set of status values corresponding to each of the pixels of the panel from the panel response values. A memory configured to store the set of status values. A correction module coupled to the pixel driver can generate a set of correction signals corresponding to the status values. The patterns can be generating using, for example, discrete cosine transformations, wavelet transformations, or principal component analysis. Measurements can be taken while operating the display at multiple operating points (e.g., driving transistors in a saturation region and a linear region), allowing status values to be extracted for multiple discrete display characteristics (e.g., driving transistor TFT ageing and OLED pixel ageing).

In another aspect of the disclosure, a method of deriving a sequence of OLED status test patterns includes generating a full sequence of display patterns according to a transform function (such as discrete cosine transform and/or wavelet transform) and driving a display with each of the sequence of patterns. The method further includes sensing a property of the display for each of the sequence of patterns and deriving a pixel status model using the sensed properties and an inverse of the transform function. The method further includes identifying and deleting patterns of the sequence of patterns that contribute less than a threshold amount to the status model to derive a sparse sequence of patterns. The sparse sequence of patterns is stored in a memory.

The method can also include generating the sparse sequence of patterns, driving the display with each of the sparse sequence of patterns, and sensing a property of the display for each of the sparse sequence of patterns. A set of pixel status values (e.g., ageing and/or non-uniformity) can be extracted from the sensed properties. The pixel status values can be stored in the memory.

The present invention helps improve the display uniformity and lifetime despite instability and non-uniformity of individual devices and pixels. This technique is non-invasive and can be applied to any type of display, including AMOLED displays, and can be used as a real-time diagnostic tool to map out or extract device metrics temporally or spatially over large areas.

The foregoing and additional aspects and embodiments of the present invention will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the invention will become apparent upon reading the following detailed description and upon reference to the drawings.

FIG. 1 is a block diagram of an AMOLED display;

FIG. 2 is a block diagram of a pixel driver circuit for the AMOLED display in FIG. 1;

FIG. 3 is a block diagram of a system for measuring and correcting for AMOLED display non-uniformity;

FIG. 4 is a flowchart of a method of extracting non-uniformity information for AMOLED displays;

FIG. 5 is a flowchart of a method of developing a non-uniformity model for an AMOLED display;

FIG. 6 is a plot of spatial correlation of the panel brightness;

FIGS. 7(a)-7(j) are patterns representing principal components;

FIG. 8 shows comparisons of SPICE simulations to quadratic models;

FIG. 9 is a block diagram of a system for measuring and correcting for AMOLED display non-uniformity by extracting principal components based on a video signal;

FIG. 10 is a block diagram of a system for measuring and correcting for AMOLED display non-uniformity using a video signal as a transformation vector;

FIG. 11(a) is a picture of a pattern applied to a display and FIG. 11(b) is picture of an estimate of the ageing of the display obtained using discrete cosine transformations; and

FIG. 12(a) is a picture of actual panel ageing and FIG. 12(b) is a picture of an estimate of the ageing using principal component analysis.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

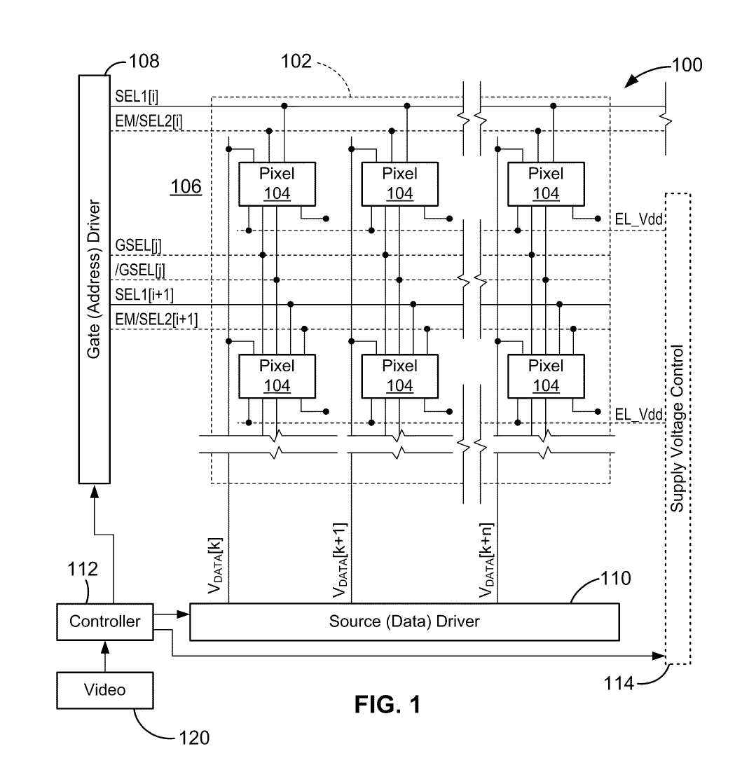

FIG. 1 is an electronic display system 100 having an active matrix area or pixel array 102 in which an array of pixels 104 are arranged in a row and column configuration. The display system 100 can be, for example, an AMOLED display. For ease of illustration, only two rows and columns are shown. External to the active matrix area of the pixel array 102 is a peripheral area 106 where peripheral circuitry for driving and controlling the pixel array 102 is disposed. The peripheral circuitry includes a gate or address driver circuit 108, a source or data driver circuit 110, a controller 112, and a supply voltage (e.g., Vdd) driver 114. The controller 112 controls the gate, source, and supply voltage drivers 108, 110, 114. The gate driver 108, under control of the controller 112, operates on address or select lines SEL[i], SEL[i+1], and so forth, one for each row of pixels 104 in the pixel array 102. A video source 120 feeds processed video data into the controller 112 for display on the display system 100. The video source 120 represents any video output from devices using the display system 100 such as a computer, cell phone, PDA and the like. The controller 112 converts the processed video data to the appropriate voltage programming information for the pixels 104 in the display system 100.

In pixel sharing configurations described below, the gate or address driver circuit 108 can also optionally operate on global select lines GSEL[j] and optionally /GSEL[j], which operate on multiple rows of pixels 104 in the pixel array 102, such as every two rows of pixels 104. The source driver circuit 110, under control of the controller 112, operates on voltage data lines Vdata[k], Vdata[k+1], and so forth, one for each column of pixels 104 in the pixel array 102. The voltage data lines carry voltage programming information to each pixel 104 indicative of a brightness of each light emitting device in the pixel 104. A storage element, such as a capacitor, in each pixel 104 stores the voltage programming information until an emission or driving cycle turns on the light emitting device. The supply voltage driver 114, under control of the controller 112, controls the level of voltage on a supply voltage (EL_Vdd) line, one for each row of pixels 104 in the pixel array 102. Alternatively, the voltage driver 114 may individually control the level of supply voltage for each row of pixels 104 in the pixel array 102 or each column of pixels 104 in the pixel array 102. As will be explained, the level of the supply voltage is adjusted to conserve power consumed by the pixel array 102 depending on the brightness required.

As is known, each pixel 104 in the display system 100 needs to be programmed with information indicating the brightness of the organic light emitting device in the pixel 104 for a particular frame. A frame defines the time period that includes a programming cycle or phase during which each and every pixel in the display system 100 is programmed with a programming voltage indicative of a desired brightness and a driving or emission cycle or phase during which each light emitting device in each pixel is turned on to emit light at a brightness commensurate with the programming voltage stored in a storage element. A frame is thus one of many still images that compose a complete moving picture displayed on the display system 100. There are at least two schemes for programming and driving the pixels: row-by-row, or frame-by-frame. In row-by-row programming, a row of pixels is programmed and then driven before the next row of pixels is programmed and driven. In frame-by-frame programming, all rows of pixels in the display system 100 are programmed first, and all the pixels are then driven row-by-row. Either scheme can employ a brief vertical blanking time at the beginning or end of each frame during which the pixels are neither programmed nor driven.

The components located outside of the pixel array 102 can be disposed in a peripheral area 106 around the pixel array 102 on the same physical substrate on which the pixel array 102 is disposed. These components include the gate driver 108, the source driver 110 and the supply voltage controller 114. Alternatively, some of the components in the peripheral area can be disposed on the same substrate as the pixel array 102 while other components are disposed on a different substrate, or all of the components in the peripheral area can be disposed on a substrate different from the substrate on which the pixel array 102 is disposed. Together, the gate driver 108, the source driver 110, and the supply voltage control 114 make up a display driver circuit. The display driver circuit in some configurations can include the gate driver 108 and the source driver 110 but not the supply voltage controller 114.

The use of the AMOLED display system 100 in FIG. 1 for applications with bright backgrounds such as emails, Internet surfing, etc., requires higher power consumption due to the need for each pixel to serve as a light for such applications. However, the same supply voltage applied to the drive transistors of each pixel is still used when the pixel is switched to varying degrees of gray scales (brightness). The current example therefore manages the supply power of the drive transistors for video data that requires higher brightness, therefore resulting in power savings while maintaining the necessary luminescence compared to an ordinary AMOLED display with a constant supply voltage to the drive transistors.

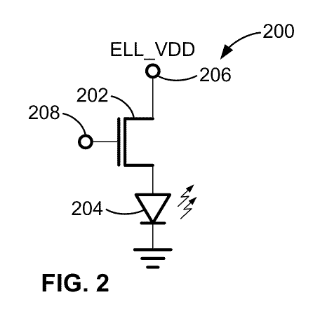

FIG. 2 is a circuit diagram of a simple individual driver circuit 200 for a pixel such as the pixel 104 in FIG. 1. As explained above, each pixel 104 in the pixel array 102 in FIG. 1 is driven by the driver circuit 200 in FIG. 2. The driver circuit 200 includes a drive transistor 202 coupled to an organic light emitting device 204. In this example, the organic light emitting device 204 is a luminous organic material which is activated by current flow and whose brightness is a function of the magnitude of the current. A supply voltage input 206 is coupled to the drain of the drive transistor 202. The supply voltage input 206 in conjunction with the drive transistor 202 supplies current to the light emitting device 204. The current level may be controlled via a programming voltage input 208 coupled to the gate of the drive transistor 202. The programming voltage input 208 is therefore coupled to the source driver 110 in FIG. 1. In one example, the drive transistor 202 is a thin film transistor fabricated from hydrogenated amorphous silicon. In another example, low-temperature polycrystalline-silicon thin-film transistor (“LTPS-TFT”) technology can also be used. Other circuit components such as capacitors and transistors (not shown) may be added to the simple driver circuit 200 to allow the pixel to operate with various enable, select and control signals such as those input by the gate driver 108 in FIG. 1. Such components are used for faster programming of the pixels, holding the programming of the pixel during different frames and other functions.

When the pixel 104 is required to have a defined brightness in applications, the gate of the drive transistor 202 is charged to a voltage where the transistor 202 generates a corresponding current to flow through the organic light emitting device 204, creating the required brightness. The voltage at the gate of the transistor 202 can be either created by direct charging of the node with a voltage or self-adjusted with an external current.

A pattern generator generates a predetermined sequence of patterns for display on a panel display. A pattern is simply a matrix of information that tells a display panel driver the level at which to drive each pixel of the display panel to form a visual image. Each of the sequence of patterns is applied to the display, one at a time. A measurement of a display property is taken for each of the sequence of patterns. For example, the overall display panel current can be measured each time a pattern is displayed on the display panel.

An individual measurement taken of the display panel for a single pattern does not give definitive information about the status (e.g., ageing, non-uniformity, etc.) of each pixel of the display panel. It does provide some information, though. For example, a pattern that causes the display panel to display white in the middle and black in the corners can be used to extract an estimate of the status of the pixels in the center of the display panel. Similarly, a pattern that causes the display panel to display black in the middle and white in the corners can be used to extract an estimate of the status of the pixels in the corners of the display. These are examples of low frequency patterns—there is a low frequency of change from pixel to pixel. A checkerboard pattern is an example of a higher frequency pattern, where there is a higher frequency of change from pixel to pixel.

A few measurements can be used to form a crude estimate of the status of the pixels in the display panel. Increasing the number of patterns and corresponding measurements increases the accuracy of the estimate of individual pixel status. By applying every possible pattern and measuring the corresponding results, there is enough information to mathematically determine an exact status value (e.g., ageing value, non-uniformity value, etc.) of each pixel. According to an aspect of the invention, certain patterns can be chosen to optimize the amount of information that can be extracted from a reduced number of patterns. Thus, accurate estimates of the status of the individual pixels can be determined without applying every possible pattern.

The status of the pixels can be represented mathematically as a vector, A. The goal is to mathematically compute each individual value in the vector A. The display panel measurements can be used to compute another vector, M, an example of which is provided below. Matrix multiplication can then be used to solve for each individual pixel value in the vector A using the values in M. An orthogonal transformation matrix, W, can be used in this computation. The transformation W can be used to create the patterns, and the inverse of that transformation, W⁻¹, can be used to solve for the individual values of vector A based on the measurements resulting from the patterns. Specifically, the values of A can be calculated according to the equation A=W⁻¹×M.

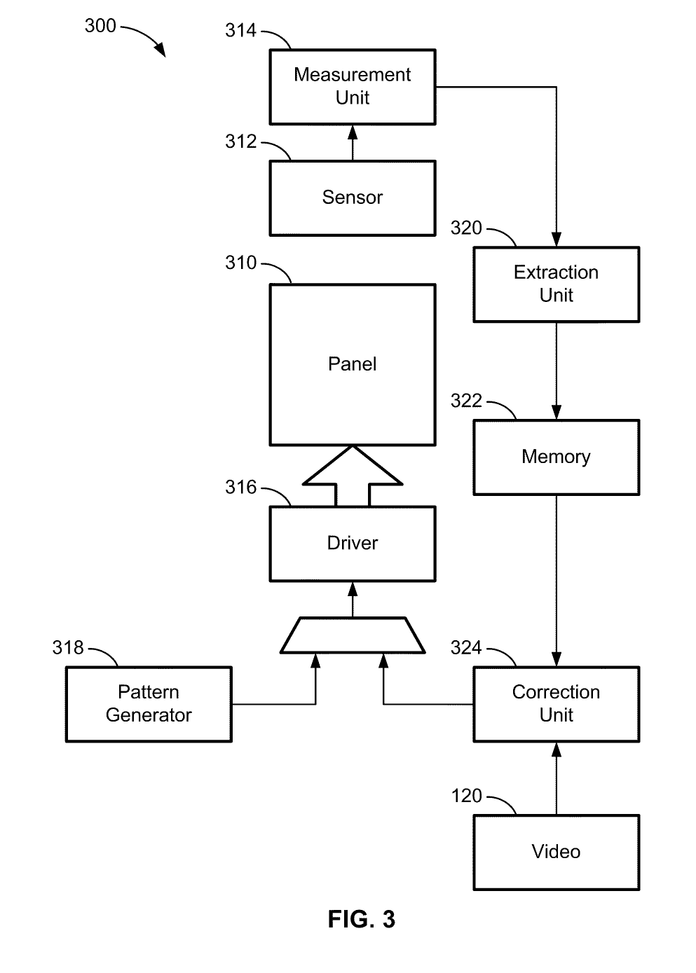

FIG. 3 illustrates an embodiment of a system 300 to measure properties of a display 310, such as an AMOLED panel display, to capture pixel metrics, for example ageing or non-uniformity. In the example of system 300, the display panel 310 is measured with a single sensor 312 (or multiple sensors) rather than a sensor corresponding to each pixel of the display. A person of ordinary skill in the art would recognize that more than one sensor could be used, although the number of sensors is small relative to the number of pixels of the display panel 310. The sensor 312 is, for example, a current sensor that measures the power supply current through V_{DD} and/or V_{SS} lines (e.g., V_{DD} 200 of FIG. 2). Alternatively, the sensor 312 could be an optical sensor, for example measuring the total light output of the display panel 310, or a thermal sensor, for example measuring the heat output of the display panel 310. A measurement unit 314 receives the output of the sensor 312.

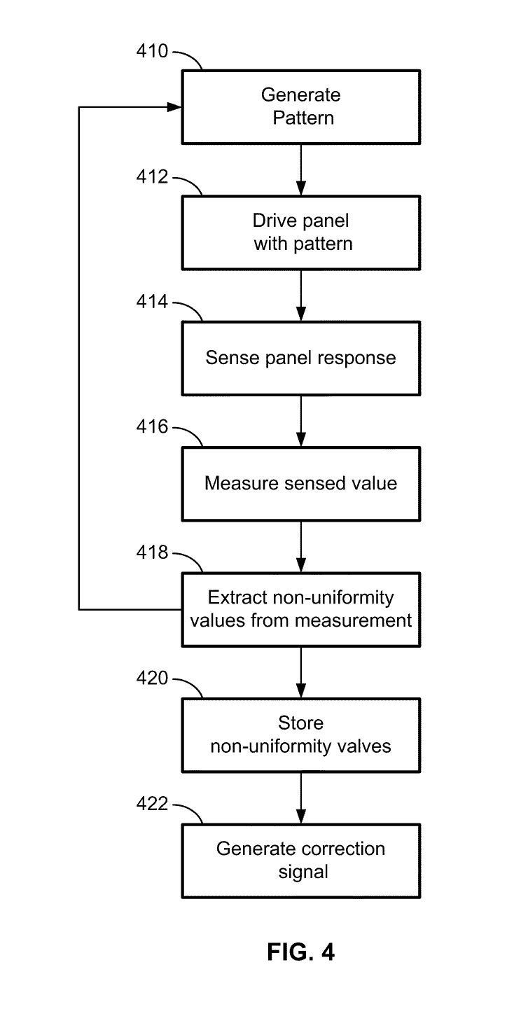

As shown in FIG. 3, and further in FIG. 4, a pattern generator 318 generates a pattern representative of an image for display on the display panel 310 (Step 410). A pattern can include a two-dimensional image of pixels (e.g., during a frame), with numerical brightness values (e.g., values in a range of 0-255) for each sub-pixel. The display panel 310 is driven by driver 316 (Step 412). The driver 316 can include, for example, the gate driver 108 and the source driver 110 of FIG. 1. During a period of pixel metrics extraction, the driver 316 is programmed to drive the display panel 310 with patterns generated by a pattern generator 318. The driver 316 converts the patterns into electrical signals to drive the display panel 310. The sensor 312 senses the response from the display panel 310 caused by the pattern driven by the driver 316 (Step 414).

The output of the sensor 312 is measured by the measurement unit 314, which converts the sensor 312 output into numerical measurement values (Step 416). The output of the measurement unit 314 is passed to an extraction unit 320 coupled to the measurement unit 314. The extraction unit 320 converts the measured data to values representing the status of individual pixels (Step 418). The patterns generated by the pattern generator 318 can be created according to a waveform transformation. The extraction unit 320 then evaluates the measurements from the measurement unit 314 using the inverse of the waveform transformation used in generating the patterns. For example, the extraction unit 320 can implement a sub-pixel electrical model and an ageing or parameter transformation. The extraction unit 320 can iteratively calculate the status values, for example updating approximations of the pixel status values as it receives additional measurements. Extraction of status data (such as ageing) through the use of a sensor and model characterizing the display (such as a sub-pixel electrical model) allows the display to be tested in a non-invasive fashion.

The status values can be stored in a memory 322 (Step 420). The stored status values can be used by a correction unit 324 coupled to the memory 322 to compensate for the ageing, non-uniformity, and other effects determined by the extraction unit 320 (Step 422). For example, the system 300 receives an input video signal 120 for display on the display panel 310. The input video signal 120 can be received by the correction unit 324, which can adjust the signal for each pixel or sub-pixel to compensate for the determined ageing of that pixel or sub-pixel.

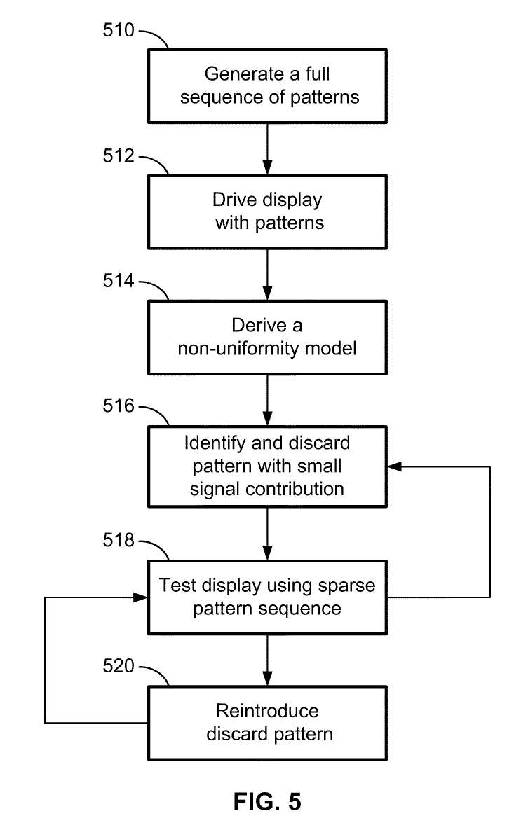

As shown in FIG. 5, the display 310 can be initially tested using a full set of patterns. As explained below, this can correspond to four times the number of pixels in the panel display. In this case, the pattern generator 318 iteratively generates each of the full sequence of patterns (Step 510), and the driver 316 causes the display panel 310 to display images corresponding to those patterns (Step 512). The extraction unit 320 derives a non-uniformity model based on the responses of the display panel 310 to the patterns (Step 514). The extraction unit can identify which of the full set of patterns contributes the most to the non-uniformity model (e.g., above a threshold value) and which patterns contribute the least (e.g., below the threshold value). The patterns that contribute the least can be discarded (Step 516).

In a subsequent test of the display panel 310, the pattern generator can generate a sequence of patterns that excludes the discarded patterns (Step 518). The extraction unit 320 can re-evaluate the non-uniformity model and discard additional patterns if it identifies patterns that contribute little to the non-uniformity model. Since display status may be difficult to predict, a discarded pattern may turn out to have more value in the future. Accordingly, discarded patterns can be re-introduced (Step 520), and the display panel 310 can be tested with a pattern sequence including the formerly discarded pattern.

A. Sub-Pixel Electrical Models

The extraction unit 320 can be configured to evaluate display status, such as display ageing, using a sub-pixel electrical model. To extract the ageing of each sub-pixel, the extraction unit 320 can construct a model for the sensor output for each sub-pixel based on the input of the sub-pixel. The model can be based on measuring the output of the sensor 312 (e.g. supply current) for a sequence of applied images (generated by pattern generator 318), and then extracting, using the extraction unit 320, a parameter matrix of the TFT and/or OLED current-voltage (I-V) ageing or mismatch values.

The supply current I₂ of a sub-pixel biased in the saturation region follows a power-law relation with respect to input data voltage as:

I₂=β₁(V_{G}−Vₒₛ−V_{Ta}−V_{Oa})^{a} (1)

Where β₁, Vₒₛ, and a, are model coefficients, V_{G} is the gate voltage of the driving TFT (e.g., transistor 202 of FIG. 2) equal to the voltage of the input video signal from the driver 316. V_{Oa} and V_{Ta} are the ageing voltage of the OLED and TFT (e.g., OLED 204 and transistor 202 of FIG. 2) such that to maintain their currents to the level equal to when they were not aged, a higher voltage (V_{Oa}+V_{Ta}) can be used. This model is valid for V_{G}>Vₒₛ+V_{Ga}+V_{Ta}.

The supply current I₂ of a sub-pixel can also be modeled with the driving transistor in the linear region, where the supply voltage V_{DD} is pulled down significantly. The operation in the linear region can be used to decompose ageing estimations into the OLED and TFT portions. The current I₂ of the driving transistor in the linear region can be approximated by:

I₂=β₁(V_{G}−Vₒₛ−V_{Ta}(y+θV_{G})V_{Oa}) (2)

Where β₁, Vₒₜ, y, θ are model coefficients.

Values for the coefficients of the models of Equations (1) and (2) can be determined by supplying to the panel 310 patterns generated by the pattern generator 318 including solid mono-color (red, green, or blue) gray-scale images, and measuring the sensor 312 output (e.g., the supply current of the whole panel) corresponding to each pattern. In this example, the extraction unit 320 can include a look-up-table that maps the gray-scale to the gate voltage, V_{G}. The extraction unit 320 can then use the measured currents to fit the models. The patterns applied by the pattern generator 318 can be constructed under a short range of the gray-scale, to fit the models with the gray-scale range that is actually being used throughout the ageing profile extraction, rather than the full 0-255 range.

Instead of, or in addition to driving the driving transistors of the panel alternately in the linear and saturation regions, the driving transistors can be driven with voltages offset by an offset value. For example, a first set of measurements can be taken with the driving transistors driven with no offset (e.g., a DC offset of zero, or a gray scale value of 127). A second set of measurements can be taken with the driving transistors driven with a DC offset or bias. From these two sets of measurements, two discrete display characteristics (e.g., driving transistor TFT ageing and OLED pixel ageing). Moreover, the driving transistors can be driven in more than two operating positions (e.g., three discrete offset points, multiple offset points and saturation region, etc.) to generate measurements for evaluating more than two discrete display characteristics.

B. Direct Extraction of Ageing and Non-Uniformity Profiles' Transformations

As explained above, the ageing values of the pixels of a display panel can be represented as a vector. For example, the ageing of the pixels and sub-pixels of the display 310 can be represented as a vector of numerical values, A. Likewise, the display panel measurements can be used by the extraction unit 320 to calculate a vector M to help solve for the ageing values in A.

The pattern generator 318 generates a sequence of patterns that are used by the driver 316 to generate images on the display 310. Each pattern represents a two-dimensional matrix of pixel values. Different patterns cause images to be displayed that carry different information about the display's ageing. For example, a pattern can be generated that results in an image that is all white. The measurement taken from this image represents the ageing of the entire display 310. Another pattern can be generated that results in an image that is white in the center and dark in the corners. The measurement taken from this image represents the ageing in the middle of the display 310. The extraction unit 320 can obtain an accurate calculation of the ageing values for each of the pixels and sub-pixels by evaluating a sufficient number of measurements corresponding to patterns supplied by the pattern generator 318 and computing a matrix of ageing values.

The orthogonal transformations of the ageing and non-uniformity profiles of the display 310 can be directly obtained by applying proper image sequences using the pattern generator 318 and measuring the corresponding output of the sensor 312 (e.g., supply current).

For example, the display 310 can be represented as an rxc pixel matrix (matrix of size r rows times c columns). The V_{Ta}+V_{Oa} ageing values of the pixels in the matrix can be rearranged in a column vector A of length rxc so that the first column of the pixel matrix consisting of r pixels sits on top of the vector A.

W_{rcxrc} is an orthogonal transformation matrix (that is W⁻¹=W^{T}). If the vector of M_{rcx1}=W_{rcxrc}×A_{rcx1} can be obtained by any means, then A, the vector of all V_{Ta}+V_{Oa} ageing values for the display 310, can be recovered by: A=W^{T}×M. In practice, this large matrix multiplication can be reduced to very fast forms of computations. For example if W is a transformation matrix of a two-dimensional discrete cosine transform (DCT), the matrix multiplication can be reduced to the inverse DCT operation.

The extraction unit 320 can include a microprocessor configured to compute the vector M as follows. The total supply current I for the panel 310 for a pattern supplied to the panel 310 can be represented by the equation:

$$\begin{matrix}I = {β}_{2} {\sum }_{i = 1}^{rc} {( {V}_{G} ( i ) - {V}_{OS} - A ( i ) )}^{a} \\ = {β}_{2} {\sum }_{i = 1}^{rc} ( {( {V}_{G} ( i ) - {V}_{OS} )}^{a} {( 1 - \frac{A ( i )}{{V}_{G} ( i ) - {V}_{OS}} )}^{a} )\end{matrix} \qquad ( 3 )$$

By using the Taylor approximation of 1−x^{a}˜1−ax, the Equation (3) can be approximated as:

$$I = {β}_{2} {\sum }_{i = 1}^{rc} ( {( {V}_{G} ( i ) - {V}_{OS} )}^{a} - {a ( {V}_{G} ( i ) - {V}_{OS} )}^{a - 1} A ( i ) ) \qquad ( 4 )$$

The pattern generator 318 can generate two different patterns (vectors) to be applied as images, V_{G1} and V_{G2}, to the display 310, and their corresponding supply currents, I₁ and I₂, can be measured using the measurement unit 314. V_{G2} can be the negative of V_{G1}, for example. The following equation can be derived using the measurements of I₁ and I₂:

$$\frac{{I}_{2} - {I}_{1}}{{β}_{2}} - {\sum }_{i = 1}^{rc} ( {( {V}_{G 2} ( i ) - {V}_{OS} )}^{a} - {( {V}_{G 1} ( i ) - {V}_{OS} )}^{a} ) = {\sum }_{i = 1}^{rc} a ( {( {V}_{G 1} ( i ) - {V}_{OS} )}^{a - 1} - {( {V}_{G 2} ( i ) - {V}_{OS} )}^{a - 1} ) A ( i ) \qquad ( 5 )$$

Equation (5) can be used to generate the B times of the j-th element of vector M, for i={1, . . . , rc}:

a((V_{G1}(i)−Vₒₛ)^{a-1}−(V_{G2}(i)−Vₒₛ)^{a-1})=B−W(j,i) (6)

To obtain the j-th element of M two patterns can be supplied with the following gate voltages:

$${V}_{G 1} ( i ) = {( C + B \frac{W ( j , i )}{2 a} )}^{\frac{1}{a - 1}} + {V}_{OS} \\ {V}_{G 2} ( i ) = {( C - B \frac{W ( j , i )}{2 a} )}^{\frac{1}{a - 1}} + {V}_{OS} \qquad ( 7 )$$

The values of B and C can be calculated using the maximum absolute value of the j-th row of W and a gate voltage range that turns pixels on but does not overdrive them. For example, for i={1, . . . , rc}, if the max([W(j,i)])=Wᵢ and the proper gate voltage range is between νₘᵢₙ and νₘₐₓ then:

$$C = 0.5 ( {( {v}_{max} - {V}_{OS} )}^{a - 1} + {( {v}_{min} - {V}_{OS} )}^{a - 1} ) \\ B = \frac{a}{{w}_{j}} ( {( {v}_{max} - {V}_{OS} )}^{a - 1} - {( {v}_{min} - {V}_{OS} )}^{a - 1} ) \qquad ( 8 )$$

The extraction unit 320 can compute the two patterns corresponding to V_{G1} and V_{G2} gate voltages by using the look-up table that maps the gray-scale level to voltage. The supply currents can be measured for each pair of images and the corresponding element of the M vector can be calculated using the left hand side of Equation (5) divided by B. The extraction unit 320 can be configured to compute an estimation of the OLED plus TFT ageing profile for the vector A by performing an inverse transformation over M using W^{T}.

The vector A can be computed iteratively, and the error introduced by the first order Taylor approximation can be compensated for by using the estimated A and a previous computation of A, A_{old}, and rewriting Equation (5) as:

$${\sum }_{i = 1}^{rc} a ( {( {V}_{G 1} ( i ) - {V}_{OS} )}^{a - 1} - {( {V}_{G 2} ( i ) - {V}_{OS} )}^{a - 1} ) A ( i ) \qquad ( 9 )$$

Iterating over Equation (9) gradually removes the errors of the high order terms neglected in the Taylor approximation. The iteration can be continued until the error is less than a threshold value.

The vector A includes values representing the sum of the OLED and TFT ageing, but not the individual contributions from OLED and TFT ageing separately. The individual contributions of the OLED and TFT ageing can also be obtained. To determine the individual contributions, the drain bias voltage of the TFTs (e.g., the transistor 202 of FIG. 2) can be pulled to a point where the sub-pixels operate in the linear region. In that region, the current of a TFT is a function of drain-source voltage. To compensate for the OLED ageing, a higher absolute voltage value must be applied to the TFT gate than a value corresponding to the actual amount of the OLED ageing. That is because of the fact that the higher OLED voltage that generates the same OLED current also lowers the drain-source voltage. The lowered drain-source voltage must be compensated with even higher gate voltage. This is modeled in Equation (2) as a V_{G-} dependent factor of the OLED ageing, Vₒₐ.

The supply current in the linear region can be represented by the equation:

$$I = {β}_{1} {\sum }_{i = 1}^{rc} ( {V}_{G} ( i ) - {V}_{ot} - A ( i ) + {V}_{oa} ( i ) - ( y + θ {V}_{G} ( i ) ) {V}_{oa} ( i ) ) \qquad ( 10 )$$

### Therefore,

$$\frac{{I}_{2} - {I}_{1}}{{β}_{2}} - {\sum }_{i = 1}^{rc} ( ( {V}_{G 2} ( i ) - {V}_{ot} - A ( i ) ) - ( {V}_{G 2} ( i ) - {V}_{ot} - A ( i ) ) ) = {\sum }_{i = 1}^{rc} ( ( {V}_{G 1} ( i ) - {V}_{G 2} ( i ) ) θ {V}_{oa} ( i ) ) \qquad ( 11 )$$

A suitable gate voltage within a preferred range that creates the B times of j-th element of vector M is

$${V}_{G 1} ( i ) = C + B \frac{W ( j , i )}{2 θ} \\ {V}_{G 2} ( i ) = C - B \frac{W ( j , i )}{2 θ} \qquad ( 12 )$$

where

$$C = 0.5 ( {v}_{max} + {v}_{min} ) \\ B = \frac{θ}{{w}_{j}} ( {v}_{max} - {v}_{min} ) \qquad ( 13 )$$

To exactly extract the OLED and TFT ageing values, 4 rc measurements, corresponding to 4 rc patterns, are needed. 4 rc corresponds to each of the rc patterns, its negative, and the corresponding measurements with the TFTs in the linear region to differentiate OLED ageing from TFT ageing. However, according to the present invention, an approximate estimation of ageing can be obtained with only a subset of the 4 rc measurements, corresponding to, for example, a few rows of M. A vector A is called R-Sparse if its transformation using the W transformation matrix (dictionary) can be well approximated with only R nonzero elements. When a suitable transformation is used, and only the rows of W that generate significant nonzero elements in M are used, the reconstruction of ageing can be performed with a significantly lower number of patterns and current measurements. Appropriate reduced sequences of patterns can be selected in a number of ways.

1. Discrete Cosine Transformation

A reduced set of patterns can be identified using a two-dimensional discrete cosine transformation (DCT). The pattern generator 318 can generate patterns created using a DCT. The extraction unit 320 then evaluates the measurements from the measurement unit 314 using the inverse of the DCT in constructing a matrix of ageing values.

A DCT is a transformation that expresses a sequence of data points in terms of a sum of cosine functions oscillating at different frequencies. The DCT is well known for its energy compaction behavior; most of the variance (energy) of the signal can be captured by its first transformation coefficients. The two-dimensional DCT rearranged in the W matrix is:

For n₁=[0, . . . , c−1], n₂=[0, . . . , r−1], k₁=[0, . . . , c−1], and k₁=[0, . . . , r−1]:

$$C = 0.5 ( {v}_{max} + {v}_{min} ) \\ B = \frac{θ}{{w}_{j}} ( {v}_{max} - {v}_{min} ) \qquad ( 13 )$$

### Where

$$\{ \begin{matrix}{a}_{Θ} = \frac{1}{\sqrt{2}} \\ {a}_{i} = 1\end{matrix} \\ i \neq 0$$

The energy compaction property of the DCT implies that by using a limited number of rows of W, in particular those rows with small k₁ and k₂, the major elements of M may be obtained and used to almost exactly reconstruct ageing. The pattern generator 318 can generate a full set of patterns based on the DCT, and the extraction unit 320 evaluates the measurements that result. The extraction unit 320 can then identify the patterns that contribute the most to the major elements of M. In subsequent tests, the pattern generator 318 can generate a reduced sequence of patterns limited to the patterns identified as the best by the extraction unit 320. If only the first few low-spatial frequency harmonics of the ageing profile are considered, the ageing profiles generated can be blurred due to the filtration of the high frequency edges. This can be solved by progressively performing measurements using selected higher frequency patterns during the operation of the display.

Because most of the variance of the signal can be captured by the first transformation coefficients, the extraction unit 320 can begin solving for, and deriving an accurate approximation of, the status values before all of the patterns have been generated and measured.

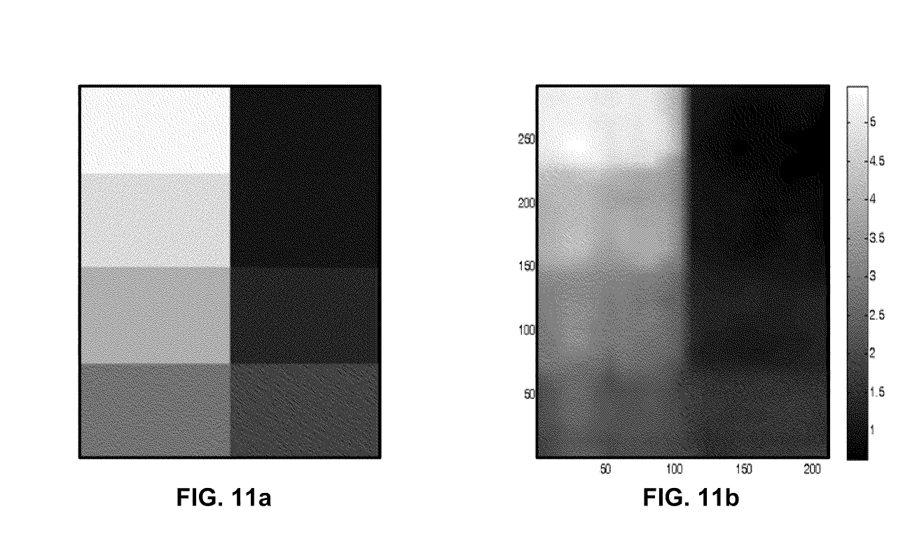

FIG. 11(a) shows an example ageing pattern consisting of eight discrete gray-scale blocks from full white to full black on a display of resolution 320 by 240 by RGB pixels. The pattern was applied to the display for forty days at a temperature of 70 degrees Celsius. The display was measured according to the invention using DCT. FIG. 11(b) shows an estimate of pixel ageing of the display using 1,000 measurements. As can be seen, a close estimate of the ageing of the display can be obtained with significantly fewer measurements than measuring each pixel individually.

2. Wavelet Transformation

Wavelets can also be used to construct orthogonal transformation matrices. The pattern generator 318 can generate patterns created using a Wavelet Transformation. The extraction unit 320 then evaluates the measurements from the measurement unit 314 using the inverse of the Wavelet Transformation in constructing a matrix of ageing values.

The advantage of wavelet transformations is the high quality detection of the ageing profile high-frequency edges. There are different types of wavelets. Unlike the DCT, with wavelet transformations, there may be a lack of knowledge of where the significant signal transformed coefficients reside. However, the knowledge of a previous ageing extraction profile can be used to find the possible location of the coefficients with significant contribution to the signal energy. The wavelet transformations can be used in conjunction with other methods after finding an initial profile. For example, the pattern generator 318 can generate a set of patterns based on the DCT, and the extraction unit 320 can extract an ageing profile including coefficients with significant contribution to the signal energy from that set of patterns. The pattern generator 318 can then generate, and the extraction unit 320 can evaluate, a set of patterns based on the Wavelet Transformation, leading to better detection of high-frequency edges.

3. Selecting the Optimum Set of Transformation Vectors

For both discrete cosine and wavelet transforms some vectors have more information about the ageing profile of the display 310 than others. To reduce the number of patterns used to extract the ageing accurately, the extraction unit 320 can select the vectors that add more information to the ageing profile and exclude those vectors that add little information. For example, the pattern generator 318 can generate a full set of vectors, using cosine and/or wavelet transforms, from which the extraction unit 320 can identify the vectors that have smaller coefficients, for example below a threshold value, and thus add little to determination of the ageing profile. The extraction unit 320 can then cause those vectors to be dropped from subsequent tests of the display 310. The next time the display 310 is analyzed, the pattern generator 318 can generate a set of patterns that excludes the dropped vectors. The extraction unit 320 can drop vectors iteratively. For example, each time the display 310 is tested, the extraction unit 320 can identify vectors that do not contribute substantially, and cause those to be dropped from subsequent tests.

This method works very well for a device with a fixed ageing profile. For a device with a dynamic ageing pattern, the coefficients of transformation vectors may change. Patterns that were excluded may later turn out to contribute more to the ageing profile, while the included patters may turn out to contribute less. To compensate for a dynamic ageing profile, dropped vectors can occasionally be added back to the set of active vectors in subsequent tests of the display 310, for example randomly or according to cyclic methods.

Because the patterns that contribute most to the status values can be identified, the pattern generator 318 can be configured to generate those patterns first, and the extraction unit 320 can begin solving for, and deriving an accurate approximation of, the status values before all of the patterns have been generated and measured.

4. Principal Component Analysis

Principal component analysis (“PCA”) can also be used to generate a dictionary of the most important features that can be used for an efficient decomposition of the ageing profile into a small set of orthogonal basis. The pattern generator 318 can then be configured to use a corresponding set of patterns, and the extraction unit 320 is configured to evaluate the measurements using the information from the principal components dictionary. To utilize PCA, a training set of sample ageing profiles is first constructed. Such a training set can be obtained from the usage pattern of the display 310 in real-time. The training set of sample ageing profiles can also be created from off-line patterns provided by extensive study of possible display usage of a device.

For example, pixel ageing can be studied under several typical usage conditions for a display. A training set of sample ageing profiles can be created for each of these conditions. Training profiles can also be created for particular manufacturers, or displays manufactured at a particular factory, through testing of several samples of displays from that manufacturer or factory. This technique can be used to better match the training profiles to non-uniformity corresponding to the particular manufacturer of factory. The patterns included in the training sets can be represented in the form of a DCT or Wavelet Transformation for ease of extraction.

To create a training set when N ageing profile samples are available, a matrix P_{rcxN} is formed such that each column is an ageing profile rearranged column-by-column in a column vector of size rc. If S=P×P^{T}, then the eigenvalue vector and eigenvector matrix of Z are λ and A. An orthogonal transformation can then be formed by picking the first few eigenvectors corresponding to the largest eigenvalues.

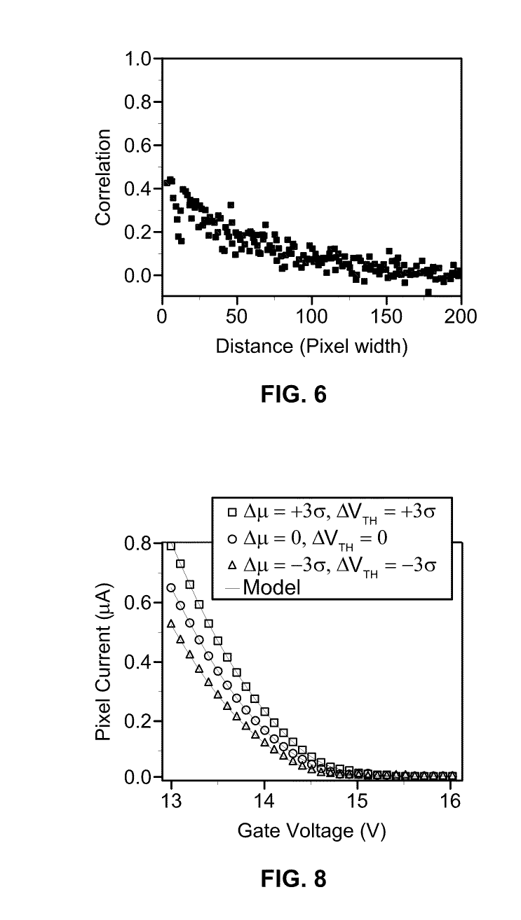

The spatial correlation of a scalar random variable Z on a 2-D plane can be formed by determining the cov(Z(s1), Z(s2)) at any arbitrary locations of s1 and s2. In a second-order stationary process, the spatial covariance is a function of the direction and distance (for an anisotropy process) between the two points rather than their actual position. The correlation generally reduces as the distance increases. There is also a spatial correlation in threshold voltage and mobility of LTPS TFTs known as long-range variation. FIG. 6 shows a plot of spatial correlation of the panel brightness. The correlation reduces as the distance between two points increases.

Since the random parameters are spatially correlated, principal component analysis is very effective in compressing the random parameters. Principal component analysis linearly transforms the underlying data to a new coordinate system such that the greatest variance appears on the first coordinate (the first principal component), the second greatest variance on the second coordinate, and so on. If the profile of the random parameter is decomposed to a weighted sum of the principal components, the dimension of the original data (dimension being the number of sub-pixels for each process parameter) can be significantly reduced in the principal component analysis coordinate system by eliminating the less important principal components.

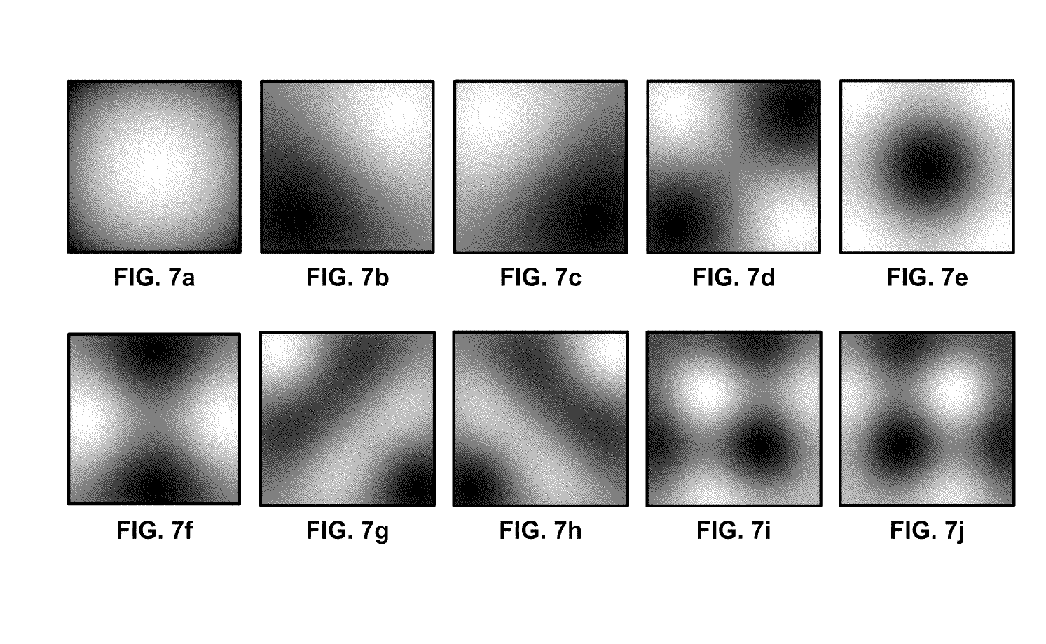

If E_{z} is the spatial covariance matrix of a process parameter Z, Σ_{Z}(i,j)=cov(Z(sᵢ), Z(sj)), the m principal components of this process parameter is equivalent to the m eigenvectors of ΣZ corresponding to its m largest eigenvalues. FIG. 7(a)-7(j) show ten patterns representing the first ten principal components of the spatial correlation matrix according to the data points of FIG. 6. In this example, the first ten principal components, which capture most of the variance, primarily contain low spatial frequencies, representing global non-uniformity trends.

As a voltage programming pixel, a driving transistor must supply a certain amount of current determined by the OLED optical efficiency, for a given gate voltage, regardless of the OLED bias. Therefore, in this example, the driving transistor of the pixel shown in FIG. 2 is biased in a way that it remains in strong saturation for the entire range of the gray-scale OLED operation. Consequently, the OLED current-voltage (“I-V”) shift effect, due to electrical ageing, on the current of the driving TFT will also be minimized.

The following model represents the process variation effect on the I-V of the pixel:

I=β(μ+Δμ)(V_{DD}−(V_{G}+V_{THo}+ΔV_{TH})² (15)

where μ₀ is the and Δμ are the nominal and variation of the transistor mobility, V_{THo} and ΔV_{TH} are the nominal and variation of the effective threshold voltage.

FIG. 8 shows comparisons of SPICE simulations to quadratic models at the nominal and two extreme process corners. The model at the nominal includes the values Δμ=0 and ΔV_{TH}=0 for Equation (15). The model at the first process corner includes the values Δμ=+3σ and ΔV_{TH}=+3σ. The model at the second process corner includes the values Δμ=−3σ and ΔV_{TH}=−3σ. Using these models, a coefficient of determination, R², can be calculated to be approximately 0.98 for the gate voltage range of 13-14 V. Therefore, this voltage range can be used as Vₘᵢₙ and Vₘₐₓ values by the extraction unit 320 in the non-uniformity extraction phase discussed below.

Similar to the examples above, the vertical mura and the coefficients of the major principal components of the background non-uniformity of both mobility and the threshold voltage can be extracted by displaying appropriate images on the panel, sensing the total current of the panel, and post-processing of the data.

The following equation represents the total current of a panel of size R×C:

$${I}_{p} = β {\sum }_{i , j = 1}^{RC} ( {μ}_{o} + Δ {μ}_{ij} ) P \frac{2}{ij} {( 1 + \frac{Δ {V}_{{TH}_{ij}}}{{P}_{ij}} )}^{2} \qquad ( 16 )$$

where Pᵢⱼ=V_{DD}+V_{TH}_{_{O}} is the drive-in voltage of the pixel at the i-th row and j-th column. For the gate voltage range of 13-14 V, since

$$\frac{Δ {V}_{{TH}_{ij}}}{{P}_{ij}} << 1 ,$$

the equation is approximated as

$${I}_{p} = β {\sum }_{i , j = 1}^{R , C} P ij ( {μ}_{o} + Δ {μ}_{ij} ) ( {P}_{ij} + 2 Δ {V}_{{TH}_{ij}} ) \qquad ( 17 )$$

Equation (17) can be used to derive the vertical average and the coefficients of the principal components, all of which are weighted sums of a type of a process parameters.

In this example, the vertical laser scan impact on the mobility is first extracted. The average mobility of each column is computed by displaying two patterns on the column (i.e., as described above using the pattern generator 318 and panel driver 316) and measuring their respective currents (i.e., as described above using the sensor 312 and measurement unit 314). While the rest of panel is programmed by full V_{DD} gate voltage (to turn off the drive TFTs for the rest of the pixels) the column of interest is driven by two different constant voltages, V_{G}⁽¹⁾ and V_{G}⁽²⁾ sequentially. The choice of the voltages can be made in a way that the gate voltage must be set within the range of the I-V model validity. If the measured current of the corresponding patterns are I₁ and I₂, the average mobility variation of the column j can then be obtained from

$$Δ {μ}_{j} = \frac{{\sum }_{i = 1}^{R} Δ {μ}_{ij} }{R} = \frac{{I}_{2} - \frac{{P}_{2}}{{P}_{1}} I 1 - R β {μ}_{oP 2} ( {p}_{2} - {p}_{1} )}{R β {p}_{2} ( {p}_{2} - {p}_{1} )} \qquad ( 18 )$$

Where p1=V_{DD}V_{TH}_{_{O}}−V_{G}⁽¹⁾ and p2=V_{DD}V_{TH}_{_{O}}V_{G}⁽²⁾

After all columns are measured, the background mobility variation (anything except vertical artifacts) can be efficiently extracted by finding the coefficients of the most important principal components. In this example, Wₘₐₓ is a principal component and Wₘₐₓ is absolute value of the largest element. For computing each principal component factor, four patterns can be displayed sequentially and the panel current can be measured for each. The four patterns provide following gate voltage profile:

$${V}_{{G}_{ij}}^{( 1 )} = {V}_{DD} + {V}_{{TH}_{O}} - {( a - \frac{{bW}_{ij}}{2} )}^{\frac{1}{2}} \\ {V}_{{G}_{ij}}^{( 2 )} = k {V}_{{G}_{ij}}^{( 1 )} \\ {V}_{{G}_{ij}}^{( 3 )} = {V}_{DD} + {V}_{{TH}_{O}} - {( a + \frac{{bW}_{ij}}{2} )}^{\frac{1}{2}} \\ {V}_{{G}_{ij}}^{( 4 )} = k {V}_{{G}_{ij}}^{( 3 )} \qquad ( 19 )$$

where k is an arbitrary constant close to 1 (e.g. 1.1), and

$$a = \frac{{( {V}_{DD} + {V}_{{TH}_{O}} - {V}_{min} )}^{2} + {( {V}_{DD} + {V}_{{TH}_{O}} - {V}_{max} )}^{2}}{2} \\ b = \frac{{( {V}_{DD} + {V}_{{TH}_{O}} - {V}_{min} )}^{2} - {( {V}_{DD} + {V}_{{TH}_{O}} - {V}_{max} )}^{2}}{{W}_{max}} \qquad ( 20 )$$

where Vₘₐₓ and Vₘᵢₙ are maximum and minimum applied gate voltages, for example 14 and 13V as described above. Such values for a and b guarantee that the gate voltage, V_{G}, stays between desired maximum and minimum levels.

If the panel current for these four patterns are measured as I₁ . . . I₄, then the coefficient of the principal component W of the background mobility non-uniformity can be computed by the extraction unit 320 as

$${\sum }_{i , j = 1}^{R , C} {W}_{ij} ( Δ {μ}_{ij} - Δ {\hat{μ}}_{i} ) = \frac{\frac{{I}_{4} - {I}_{2 - k} ( {I}_{3} - {I}_{1} )}{{k}^{2} - k} - b β μO {\sum }_{i , j = 1}^{R , C} {W}_{ij Δμ j} }{b β} \qquad ( 21 )$$

Therefore, the total number of current measurements (number of image frames to be displayed), required for the extraction of the mobility non-uniformity using the average vertical variation and the top m_{μ} principal components, is 2 C+4 m_{μ}.

Once the mobility variation profile is estimated, the threshold voltage variation can be characterized by decomposing it into vertical and background variation components. The average threshold voltage variation of a column j, can be extracted using one current measurement. In this example, the following gate voltage pattern is applied to the column while the rest of the panel is left off:

if (k=j)V_{G}_{ᵢₖ}=V_{DD}V_{TH}_{_{O}}(μₒ+Δμₘᵢₙ)

if (k≠j)V_{G}_{ᵢₖ}=V_{DD} (22)

### Where

$$c = 0.5 X ( ( {V}_{DD} + {V}_{{TH}_{O}} - {V}_{min} ) ( {μ}_{O} + Δ {μ}_{min} ) + ( {V}_{DD} + {V}_{{TH}_{O}} - {V}_{max} ) ( {μ}_{O} + Δ {μ}_{max} ) ) \qquad ( 23 )$$

This ensures that the gate voltage at the column of interest remains between the Vₘᵢₙ and Vₘₐₓ limits, so that the condition for the first order approximation model (Equation (17)) of the pixel I-V holds. Therefore, if the measured current is I, the average threshold variation of the column j is

$$Δ {\hat{V}}_{{TH}_{j}} = \frac{{\sum }_{i = 1}^{R} {Δ}_{{TH}_{ij}}}{R} = \frac{I - β {c}^{2} {\sum }_{i = 1}^{R} \frac{1}{{μ}_{O} + Δ {μ}_{ij}}}{2 β cR} \qquad ( 24 )$$

To extract the coefficients of the major principal components of the background threshold voltage variation, two measurements can be applied per coefficient, as follows:

$${V}_{{G}_{ij}}^{( 1 )} = {V}_{DD} + {V}_{{TH}_{O}} - ( d - \frac{{eW}_{ij}}{2 ( {μ}_{O} + Δ {μ}_{ij} )} ) \\ {V}_{{G}_{ij}}^{( 2 )} = {V}_{DD} + {V}_{{TH}_{O}} - ( d + \frac{{eW}_{ij}}{2 ( {μ}_{O} + Δ {μ}_{ij} )} ) \qquad ( 25 )$$

### Where

$$d = \frac{0.5}{{μ}_{o}} x ( ( {V}_{DD} + {V}_{{TH}_{O}} - {V}_{min} ) ( {μ}_{O} + Δ {μ}_{min} ) + ( {V}_{DD} + {V}_{{TH}_{O}} - {V}_{max} ) ( {μ}_{O} + Δ {μ}_{max} ) ) \\ d = \frac{1}{{W}_{max}} x ( ( {V}_{DD} + {V}_{{TH}_{O}} - {V}_{min} ) ( {μ}_{O} + Δ {μ}_{min} ) - ( {V}_{DD} + {V}_{{TH}_{O}} - {V}_{max} ) ( {μ}_{O} + Δ {μ}_{max} ) ) \qquad ( 26 )$$

The full-panel current for the displayed patterns are measured as I₁ and I₂. The coefficient of the corresponding principal component of the background threshold voltage variation is

$${\sum }_{i , j = 1}^{R , C} {W}_{ij } ( {Δ}_{{TH}_{ij}} - Δ {\hat{V}}_{{TH}_{j}} ) = - {\sum }_{i , j = 1}^{R , C} {W}_{ij } Δ {\hat{V}}_{{TH}_{j}} + \frac{\frac{{I}_{2} - {I}_{1}}{β} - {\sum }_{i , j = 1}^{R , C} ( \begin{matrix}{( d + \frac{{eW}_{ij }}{2 ( {μ}_{O} + Δ {μ}_{ij} )} )}^{2} - \\ {( d - \frac{{eW}_{ij }}{2 ( {μ}_{O} + Δ {μ}_{ij} )} )}^{2} ( {μ}_{O} + Δ {μ}_{μ ij} )\end{matrix} )}{2 e} \qquad ( 27 )$$

To estimate the threshold voltage and mobility variation profile, the total number of current measurements is 3 C+4 m_{μ}+2 mV_{TH}, where C is the number of panel columns, m_{μ} is the number of principal components used to model mobility variation component other than mura impacts, and mV_{TH} is that of the threshold voltage variation.

In order to remove the small impact of first degree approximation in the Equation (17), the computations of Equations (18), (21), (24), and (27) can be repeated by changing the value of current measurements according to the following equation:

$${I}_{new} = I - β {\sum }_{i , j = 1}^{R , C} ( {μ}_{O} + Δ {μ}_{ij} ) Δ {V}_{{TH}_{ij}}^{2} \qquad ( 28 )$$

where Δμ and ΔV_{TH} are the estimated variation from the last iteration. The subtracted term is equal to the second degree term that has been ignored by applying the first degree approximation.

The pattern generator 318 can include several sets of patterns corresponding to typical display usage. The actual usage of the display can be determined based on the display input. The actual usage can then be matched most closely with one of the typical display usage sets of patterns. Once again, because the patterns that contribute most to the non-uniformity values can be identified, the pattern generator 318 can be configured to generate those patterns first, and the extraction unit 320 can begin solving for, and deriving an accurate approximation of, the non-uniformity values before all of the patterns have been generated and measured.

If no training set is available, the spatial statistics of the ageing profiles can be used to directly construct the covariance matrix of Z. It is also possible to start with an ageing profile extracted using any other method, divide it to batch sizes of, for example 8×8 or 16×16, and use the batches as training sets. The extracted orthogonal transformation using this method can be used to locally extract the ageing (within single batches).

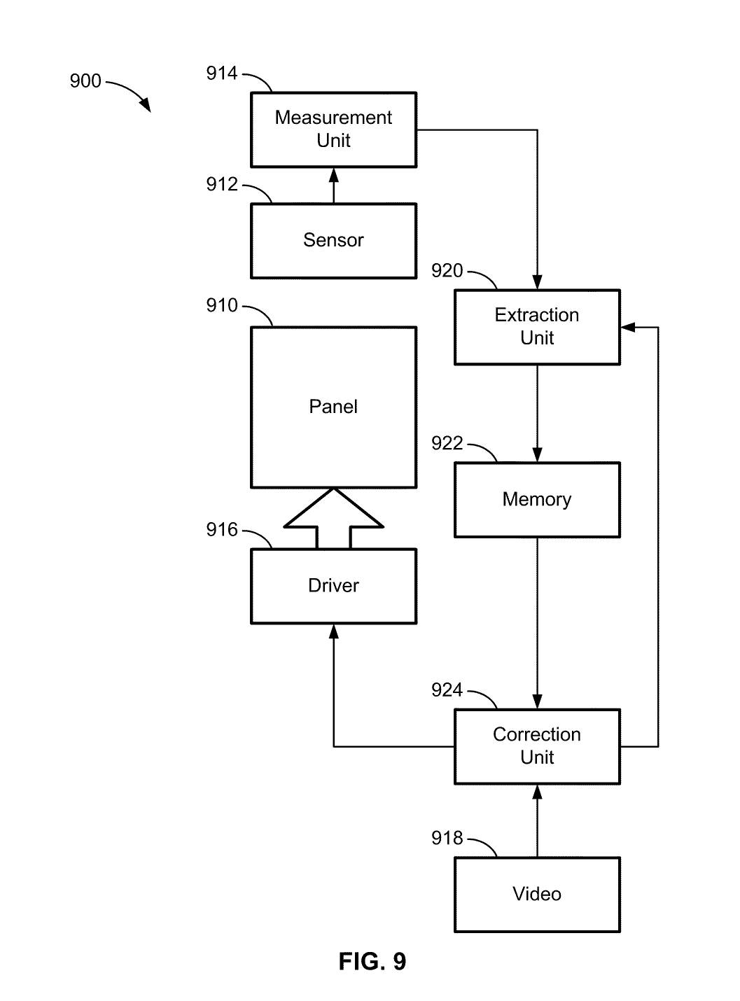

Principal components can be calculated based on a predefined ageing pattern or based on a moving averageing of the display input. FIG. 9 shows a system 900 that can be used to extract principal components for a display panel 910 based on a video signal 918. A driver 916 drives the display panel 910 according to the video signal 918. Similar to the system of FIG. 3, a sensor 912 senses a property (e.g., power supply current) of the panel 910 responsive to the driver 916. A measurement unit 914 converts the sensor 912 output into numerical measurement values, which are passed to an extraction unit 920, which evaluates the measurements. Status values calculated by the extraction unit 920 can be stored in a memory 922 for use by a correction unit 924. The video signal 918 can be periodically or continuously monitored to determine display usage. A dictionary of principal components can also be constructed based on the monitored display usage.

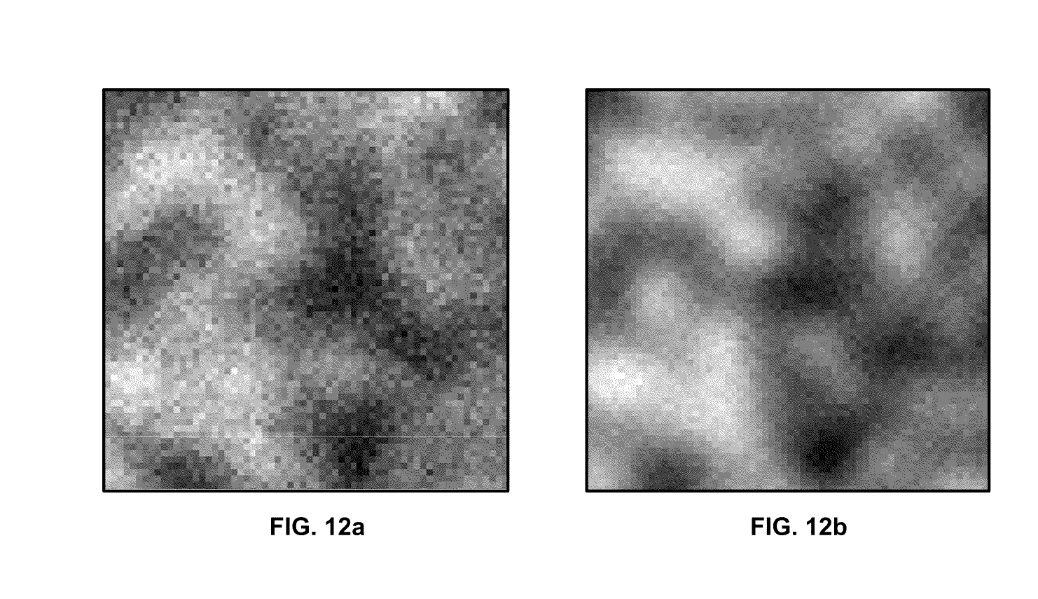

FIG. 12(a) shows an example of actual panel ageing of a 200 by 200 pixel panel. FIG. 12(b) shows an estimate of the panel ageing using principal component analysis after 200 measurements. As can be seen, a close estimate of the ageing of the display can be obtained with significantly fewer measurements than measuring each pixel individually.

5. Video Signal as Transformation Vector

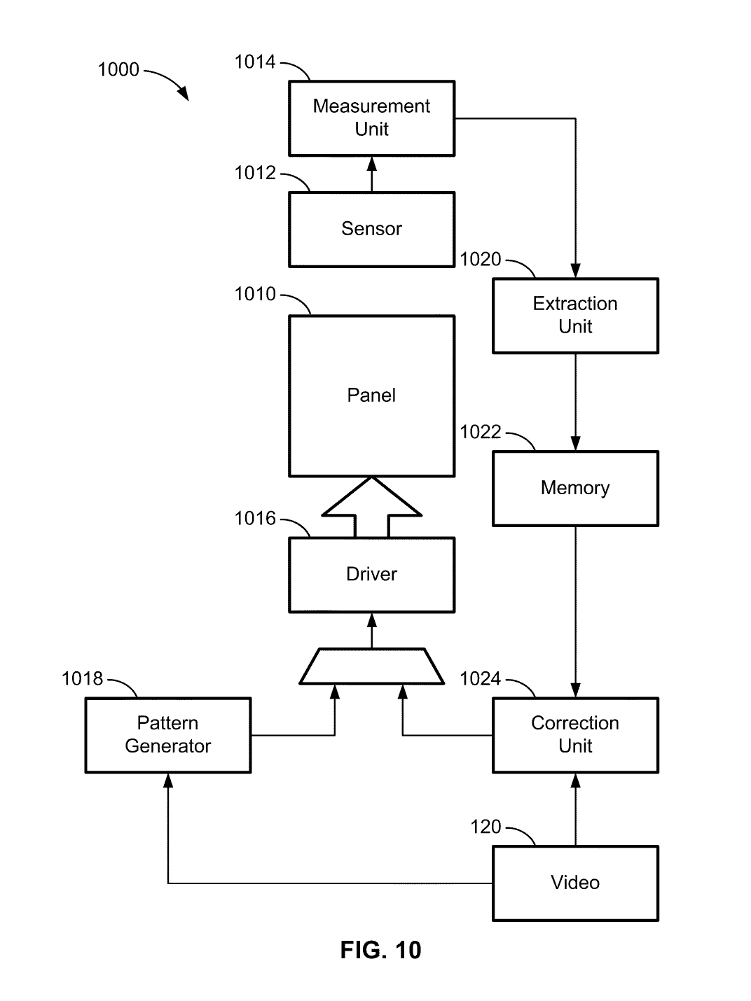

A video signal can also be used as a transformation vector. For example, each frame of a video signal can be written as a linear combination of either cosine or other waveform transformation vectors. As a result, the video can be used to extract the ageing (or pixel parameters) of the display. FIG. 10 illustrates a system 1000 for measuring and correcting for panel non-uniformity using a video signal as a transformation vector. The input video signal 120 is received by a pattern generator 1018, which converts the frames of the video signal into the form of a DCT and/or other waveform transformation. Alternatively, the input video signal 120 can be received as a series of frames in the form of a DCT and/or other waveform transformation. A driver 1016 drives the display 1010 in accordance with the patterns, and a sensor 1012 senses the results for each frame. A measurement unit 1014 measures the output of the sensor 1012 and sends the measurements to an extraction unit 1020. The extraction unit 1020 constructs a matrix of ageing values using the inverse of the transformations used to construct the patterns. The ageing values can be stored in a memory 1022, and used by a correction unit 1024 to make compensating adjustments to the input video signal 120 before it is displayed.

C. Compressive Sensing of Ageing and Non-Uniformity Profiles

Calculating a transformation vector M directly by applying proper images, reading their currents, and extracting coefficients using Equations (5, 9, and 11) is a very fast technique. However, since the energy compaction is not perfect, it is always possible that some of the measurements lead to very small transformed M elements, while some of the significant ones may be neglected. This issue degrades the accuracy of the extracted ageing profile unless the number of measurements increases significantly to compensate for the neglected transformation coefficients. If a priori knowledge on the significant transformation coefficients is available, it can be used to select which elements of M should be calculated and which should be ignored in order to obtain a high quality profile with a low number of measurements.

The quality of extracted ageing values can also be improved, while keeping the measurement numbers small, by using images of random pixels and applying basic pursuit optimization to extract the original profile. This process is similar to compressive sensing.

For example, if N images are constructed each with pixels of randomly set gray-scale, based on a uniform, Bernoulli, Gaussian, or video-content-dependent images, the ageing values can be optimized according to the following equation:

$$min {\sum }_{i = 1}^{rc} [ M ( i ) ]$$

Subject to:

$$for i = [ 1 , … , N ] \\ {I}_{j} = {β}_{2} {\sum }_{i = 1}^{rc} ( {( {V}_{G} ( i ) - {V}_{OS} )}^{a} - {a ( {V}_{G} ( i ) - {V}_{OS} )}^{a - 1} A ( i ) ) \\ A = {W}^{T} xM \qquad ( 29 )$$

Here V_{G}(i) is the gate voltage of the random pixel i at j-th image, and W^{T} the transpose of the transformation dictionary (e.g. DCT, Wavelet, PCA, etc.), and Iⱼ the current consumption of the j-th image. A linear programming, iterative orthogonal matching pursuit, tree matching pursuit, or any other approach can be used to solve this basic pursuit optimization problem.

In Equation (29), the approximated first-order Taylor current equation is used to maintain the linearity of the optimization constraint. After finding an initial estimate of the ageing, A, it can also be used to provide a closer linear approximation and by re-iterating the optimization algorithm it converges to the actual ageing profile. The new constraint used in the subsequent iterations of Equation (29) is:

$${I}_{j} = {β}_{2} {\sum }_{i = 1}^{rc} ( {( {V}_{G} ( i ) - {V}_{OS} )}^{a} ( \begin{matrix}{( 1 - \frac{{A}_{old} ( i )}{{V}_{G} ( i ) - {V}_{OS}} )}^{a} + a \frac{{A}_{old} ( i )}{{V}_{G} ( i ) - {V}_{OS}} - \\ a \frac{A ( i )}{{V}_{G} ( i ) - {V}_{OS}}\end{matrix} ) ) \qquad ( 30 )$$

Finally, to decompose the estimated ageing between the two components of OLED ageing and TFT ageing, the supply voltage can be pulled down for a new set of measurements. The new measurements can be optimized according to the following equation:

$$min {\sum }_{i = 1}^{rc} [ M ( i ) ]$$

Subject to:

$$F or i = [ 1 , … , N ] \\ {I}_{j} = {β}_{1} {\sum }_{i = 1}^{rc} ( {V}_{G} ( i ) - {V}_{ot} - Ai + {V}_{oa} ( i ) - ( y + θ {V}_{G} ( i ) ) {V}_{oa} ( i ) ) \\ {V}_{oa} = {W}^{T} xM \qquad ( 31 )$$

As can be seen, the status (e.g., ageing) of an OLED display can be evaluated, and an accurate approximation of the ageing can be obtained, using a single sensor or small number of sensors, and a reduced sequence of input patterns. Less hardware can be used to measure display status, reducing cost, and fewer computations can be used to evaluate the measurements, reducing processing time.

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

1. A method of evaluating OLED display pixel status comprising:
generating a sequence of patterns representing pixel values for a display panel, wherein the sequence of patterns is a subset of a full sequence of patterns;
driving the OLED panel with the sequence of patterns;
sensing a sequence of values representing the responses of the panel to the respective ones of the sequence of patterns;
deriving from the sensed sequence of values a matrix of status values representing pixel status of the panel; and
storing the matrix of status values in a memory.

2. The method of claim 1, further comprising applying to the panel a correction signal corresponding to the matrix of status values.

3. The method of claim 1, wherein the status values represent one or more of pixel ageing and pixel non-uniformity.

4. The method of claim 1, wherein the generating uses at least one of a discrete cosine transformation and a wavelet transformation to generate at least one of the patterns, and wherein the deriving uses an inverse of the at least one transformation.

5. The method of claim 4, further comprising:
discarding from the sequence of patterns a pattern that contributes less than a threshold amount to the matrix of status values; and
repeating the generating, driving, sensing, deriving, and storing steps.

6. The method of claim 5, further comprising:
reintroducing the discarded pattern to the sequence of patterns; and
repeating the generating, driving, sensing, deriving, and storing steps.

7. The method of claim 1, wherein the generating comprises generating at least one pattern based on a principal component analysis.

8. The method of claim 7, wherein the principal component analysis comprises generating a principal component through at least one of a predefined non-uniformity pattern and a moving averageing of an input to the OLED display.

9. The method of claim 1, wherein
driving the OLED panel comprises operating the pixel driving transistors in a first operating position and a second operating position;
the sequence of patterns includes patterns corresponding to each of the first operating position and the second operating position; and
the matrix of status values includes values corresponding to two discrete display characteristics.

10. The method of claim 9, wherein the first operating position is a linear region and the second operating position is a saturation region.

11. The method of claim 9, wherein the first operating position and the second operating position are offset by an offset voltage.

12. An apparatus for evaluating OLED display status, comprising:
a pattern generator configured to generate a sequence of pixel patterns, wherein the sequence of patterns is a subset of a full sequence of patterns;
a pixel driver coupled to the pattern generator configured to drive a display panel with the sequence of pixel patterns generated by the pattern generator;
a sensor configured to sense a panel response value corresponding to a pattern generated by the pattern generator;
an extraction module coupled to the sensor configured to extract a set of status values corresponding to each of the pixels of the panel from the panel response values; and
a memory configured to store the set of status values.

13. The apparatus of claim 12, further comprising a correction module coupled to the pixel driver configured to generate a set of correction signals corresponding to the status values.

14. The apparatus of claim 12, wherein the status values represent one or more of pixel ageing and pixel non-uniformity.

15. The apparatus of claim 12, wherein the sensor is one of a current sensor configured to sense an OLED panel V_{DD} current, an optical sensor configured to sense a light intensity of the OLED display, or a thermal sensor configured to sense a thermal value of the OLED display.

16. The apparatus of claim 12, wherein a pattern is generated using at least one of a discrete cosine transformation and a wavelet transformation.

17. The apparatus of claim 12, wherein the pattern generator is configured to discard a pattern that contributes less than a threshold amount to the matrix of status values.

18. The apparatus of claim 12, wherein the pattern generator is configured to generate at least one pattern based on a principal component analysis.

19. The apparatus of claim 18, wherein the pattern generator is configured to generate at the least one pattern through at least one of a predefined status pattern and a moving averageing of an input to the OLED display.

20. The apparatus of claim 12, wherein
the pixel driver is further configured to alternately drive the pixel driving transistors in a first operating position and a second operating position;
the sequence of patterns includes patterns corresponding to each of the first operating position and the second operating position; and
the extraction module is further configured to extract status values representative of two discrete display characteristics.

20. (canceled)

21. The apparatus of claim 20, wherein the first operating position and the second operating position are offset by an offset voltage.

22. The apparatus of claim 20, wherein the two discrete display characteristics are driving transistor ageing and OLED pixel ageing.

23. A method of deriving a sequence of OLED status test patterns comprising:
generating a full sequence of display patterns according to a transform function;
driving a display with each of the sequence of patterns;
sensing a property of the display for each of the sequence of patterns;
deriving a pixel status model using the sensed properties and an inverse of the transform function;
identifying and deleting patterns of the sequence of patterns that contribute less than a threshold amount to the status model to derive a sparse sequence of patterns;
storing the sparse sequence of patterns in a memory.

24. The method of claim 23, wherein the status values represent one or more of pixel ageing and pixel non-uniformity.

25. The method of claim 23, wherein the transform function is one of a discrete cosine transformation and a wavelet transformation.

26. The method of claim 23, further comprising
generating the sparse sequence of patterns;
driving the display with each of the sparse sequence of patterns;
sensing a property of the display for each of the sparse sequence of patterns;
extracting a set of pixel status values from the sensed properties;
storing the set of pixel status values in the memory.

27. The method of claim 23, further comprising reintroducing a deleted pattern into the sparse sequence of patterns.

28. The apparatus of claim 20, wherein the first operating position is a linear region and the second operating position is a saturation region.
